(19) United States
(12) Patent Application Publication
(10) Pub. No.: US 2025/0073793 A1
(43) Pub. Date: Mar. 6, 2025

(54) CUTTING SAW AND CONTROL METHOD OF THE CUTTING SAW

(71) Applicant: Greenworks (Jiangsu) Co., Ltd., Changzhou (CN)

(72) Inventors: Lingao Zhang, Changzhou (CN); Qiuping Feng, Changzhou (CN); Xiaohui Huo, Changzhou (CN)

(21) Appl. No.: 18/926,459

(22) Filed: Oct. 25, 2024

Related U.S. Application Data
(63) Continuation of application No. PCT/CN2023/088110, filed on Apr. 13, 2023.

(30) Foreign Application Priority Data
Apr. 27, 2022 (CN) 202221003512.X
May 13, 2022 (CN) 202210522209.9
May 13, 2022 (CN) 202221157180.0

(51) Int. Cl. B23D 47/12; B23D 45/16

(52) U.S. Cl. CPC B23D 47/12; B23D 45/16

(57) ABSTRACT

A cutting saw includes a housing, a cutting part, a driving part, a power supplying part, a lighting part and a control board. The control board is electrically connected with the power supplying part, the driving part and the lighting part respectively. An operating panel is installed on the housing. The operating panel is provided with a power supply switch, a lighting switch and an alarm light. The power supply switch, the lighting switch, and the alarm light are electrically connected with the control board. When the power supply switch is activated, a light of the power supply switch lights up. If the control board of the cutting saw does not receive any control signal input within a first time threshold, the light starts to flash. If there is still no control signal input within a second time threshold after flashing, the power supply switch enters an inactivated state.

### CROSS REFERENCE TO RELATED APPLICATION

The present application is a continuation Application of PCT application No. PCT/CN2023/088110 filed on Apr. 13, 2023, which claims the benefit of CN202210522209.9 filed on May 13, 2022, CN202221157180.0 filed on May 13, 2022 and CN202221003512.X filed on Apr. 27, 2022. All the above are hereby incorporated by reference for all purposes.

### TECHNICAL FIELD

The disclosure relates to a field of power tools, and in particular to a cutting saw and a control method of the cutting saw.

### BACKGROUND

As a portable cutting tool, cutting saws may cut materials such as stone, concrete or wood by using a cutting disc rotatably installed on a bracket for a cutting operation. However, the conventional cutting saws have a low level of intelligence and a poor user experience.

At the same time, since the cutting part (saw blade) is a consumable part in the cutting work, it is necessary to buy a lot of cutting parts. There are many cutting parts with different diameters on the market. Generally, the cutting saw machine needs to be equipped with different shaft sleeves to facilitate a use of the different shaft sleeves for matching when replacing the cutting parts with different diameters. As a result, in daily use, the saw blade is complicated to replace and the shaft sleeve is easy to lose.

### SUMMARY

One or more embodiments of the disclosure provide a cutting saw and a control method of the cutting saw, so as to improve problems of low intelligence and poor user experience of the conventional cutting saw.

One or more embodiments of the disclosure provide the cutting saw, and the cutting saw includes a cutting part, a driving part, a power supplying part, a lighting part, a control board and a housing.

The driving part supplies power to the cutting part.

The power supplying part supplies power to the cutting saw.

The lighting part provides light for the cutting saw.

The control board is electrically connected with the power supplying part, the driving part and the lighting part respectively.

The housing is provided with an operating panel, and the operating panel is provided with a power supply switch, a lighting switch and an alarm light.

The power supply switch is electrically connected with the control board and controls a switch of the power supplying part.

The lighting switch is electrically connected with the control board and controls an on-off of the lighting part.

The alarm light is electrically connected with the control board and receives a corresponding alarm signal from the control board to give an alarm.

Wherein, when the power supply switch is activated, a light of the power supply switch lights up, if the control board of the cutting saw does not receive a control signal input within a first time threshold, the light of the power supply switch starts to flash, and if there is still no control signal input within a second time threshold after flashing, the power supply switch enters an inactivated state and the light of the power supply switch is turned off.

In an embodiment of the disclosure, the power supply switch and the lighting switch are arranged at touchable positions of fingers during a cutting operation.

In an embodiment of the disclosure, the housing is provided with a battery cavity to install the power supplying part, a first handle is arranged on a side of the battery cavity away from the cutting part, the operating panel is arranged on an outer surface of the housing between the first handle and the battery cavity, and the operating panel is recessed into the outer surface of the housing by 0 mm to 2 mm.

In an embodiment of the disclosure, surfaces of the power supply switch and the lighting switch protrude from a surface of the operating panel, and the surfaces of the power supply switch and the lighting switch are lower than the housing surrounding the operating panel.

In an embodiment of the disclosure, the operating panel further includes a wiring part and a plug-in connector, the plug-in connector is electrically connected to the power supply switch, the lighting switch, and the alarm light through the wiring part, and the power supplying part, the driving part, the lighting part, and the control board are electrically connected with the plug-in connector through other wires.

In an embodiment of the disclosure, the power supply switch is centrally arranged on the operating panel and close to a direction of fingers during a cutting operation, and the lighting switch and the alarm light are located on two sides of the power supply switch.

In an embodiment of the disclosure, the lighting switch is provided with a lighting switch light capable of reflecting a state of the lighting switch, when the lighting switch is in an activated mode, the lighting switch light is white, and when the power supply switch is in an inactivated mode, the lighting switch light is off.

In an embodiment of the disclosure, the cutting saw further includes a speed regulation switch, and the speed regulation switch is electrically connected with the control board and configured to control a rotating speed of a motor in the driving part.

In an embodiment of the disclosure, the lighting part includes an LED driving board and an LED light board, the LED driving board is electrically connected with the control board, and the LED light board is electrically connected with the LED driving board.

In an embodiment of the disclosure, the cutting saw further includes a charger plugging base, the power supplying part is electrically connected with the control board, and the control board is electrically connected with the charger plugging base.

In an embodiment of the disclosure, the cutting saw further includes a shaft sleeve, and the shaft sleeve is sleeved on an output shaft of the driving part. The shaft sleeve is provided with shaft surfaces of different diameters, and the shaft surfaces are arranged on two sides of a center plane of the shaft sleeve and are installed in cooperation with the cutting part.

In an embodiment of the disclosure, a first shaft shoulder is further arranged on the shaft sleeve, the shaft surface includes a first shaft surface and a second shaft surface, the first shaft surface and the second shaft surface are arranged on two sides of the first shaft shoulder, an outer diameter of the first shaft shoulder is larger than diameters of the first shaft surface and the second shaft surface, and the diameter of the first shaft surface is larger than the diameter of the second shaft surface.

The disclosure provides a control method of the cutting saw, including:
activating the power supply switch and turning on the light of the power supply switch;
the light of the power supply switch starting to flash if the control board of the cutting saw does not receive any control signal input within a first time threshold;
the power supply switch entering the inactivated state if there is still no control signal input within a second time threshold after flashing, and turning off the power supply switch.

In an embodiment of a control method of the disclosure, when the power supply switch is in an activated mode, the light of the power supply switch is green, and when the power supply switch is in an inactivated mode, the light of the power supply switch is turned off or displayed in other colors.

One or more embodiments of the disclosure provide the cutting saw, which ensures a use of two kinds of saw blades through arranging the shaft sleeve with shaft surface of different diameters, and does not need to design the shaft sleeves of the two kinds of the saw blade at the same time, which saves costs and is convenient for daily use, saving time and effort. In addition, the shaft sleeve can match the two kinds of the saw blades of the cutting saw, so that in daily work, a user no longer needs to worry about incorrect diameters when replacing the saw blade. The two diameters of the shaft sleeves may match most saw blades on the market, which is convenient for users to use.

One or more embodiments of the disclosure provide the cutting saw, which only uses a dual-purpose shaft sleeve. The shaft sleeve is assembled on the cutting saw. If the saw blade is replaced in daily use, it is only necessary to replace the shaft sleeve in up and down directions to match the saw blade with the corresponding diameters, which is convenient and simple, and very user-friendly. The saw blade may be replaced very simply and will not be lost in daily use.

One or more embodiments of the disclosure provide the cutting saw, on which the power supply switch, the lighting switch and the alarm light are centrally arranged on the same operating panel, so that a control of the cutting saw can be relatively centralized, and the cutting saw has advantages of good control experience, high intelligence, and easy detection of fault alarms.

One or more embodiments of the disclosure provide the control method of the cutting saw, which may improve an intelligence level of the cutting saw and enhance user's experience.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a front view of a cutting saw according to at least one embodiment of the disclosure.

FIG. 2 is a top view of the cutting saw according to at least one embodiment of the disclosure.

FIG. 3 is a schematic structural view of an operating panel of the cutting saw of the disclosure.

FIG. 4 is a view of the cutting saw from another direction according to at least one embodiment of the disclosure.

FIG. 5 is an electrical connection view of the cutting saw of the disclosure.

FIG. 6 is a schematic structural view of the cutting saw according to at least one embodiment of the disclosure.

FIG. 7 is a schematic assembly view of an output shaft and a saw blade according to at least one embodiment of the disclosure.

FIG. 8 is a schematic exploded view of the output shaft and the saw blade according to at least one embodiment of the disclosure.

FIG. 9 is a schematic structural view of a cross-section along A-A in FIG. 7.

FIG. 10 is a schematic structural view of the output shaft in the cutting saw according to at least one embodiment of the disclosure.

FIG. 11 is a schematic structural view of a shaft sleeve in the cutting saw according to at least one embodiment of the disclosure.

FIG. 12 is a schematic structural view of a first pressing plate in the cutting saw according to at least one embodiment of the disclosure.

FIG. 13 is a control logic view of a power supply switch in the cutting saw of the disclosure.

### PART NUMBER DESCRIPTION

100—Housing, 110—first handle, 120—second handle, 130—trigger, 101—first housing, 102—second housing, 103—transmission box, 200—power supplying part, 210—charger plugging base, 300—cutting part, 400—operating panel, 401—lighting switch, 402—power supply switch, 403—alarm light, 404—wiring part, 405—plug—in connector, 500—protective cover, 510—adjusting mechanism, 600—lighting part, 610—LED driving board, 620—LED light board, 700—spraying device, 800—control board, 900—driving motor, 910—speed regulation switch, 930—transmission mechanism, 1100—shaft sleeve, 1101—first shaft shoulder, 1102—first shaft surface, 1103—second shaft surface, 301—through hole, 302—first pressing plate, 303—second pressing plate, 304—locking bolt, 3041—screw rod, 3042—nut, 30421—protruding part, 3001—middle part, 3002—edge part, 931—output shaft, 932—second shaft shoulder, 933—threaded hole, 9311—first plane structure, 9312—second plane structure.

### DETAILED DESCRIPTION

The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure. It should be noted that, the following embodiments and the features in the embodiments can be combined with each other without conflict. It should further be understood that the terms used in the examples of the disclosure are used to describe specific embodiments, instead of limiting the protection scope of the disclosure. The test methods that do not indicate specific conditions in the following examples are usually in accordance with conventional conditions, or conditions recommended by each manufacturer.

It should be noted that terms “upper”, “lower”, “left”, “right”, “middle” and “one” quoted in this specification are only for a convenience of description, and are not used to limit a scope of the disclosure. Changes or adjustments in their relative relationships shall also be regarded to be within the scope of the disclosure when there is no substantial change in the technical content.

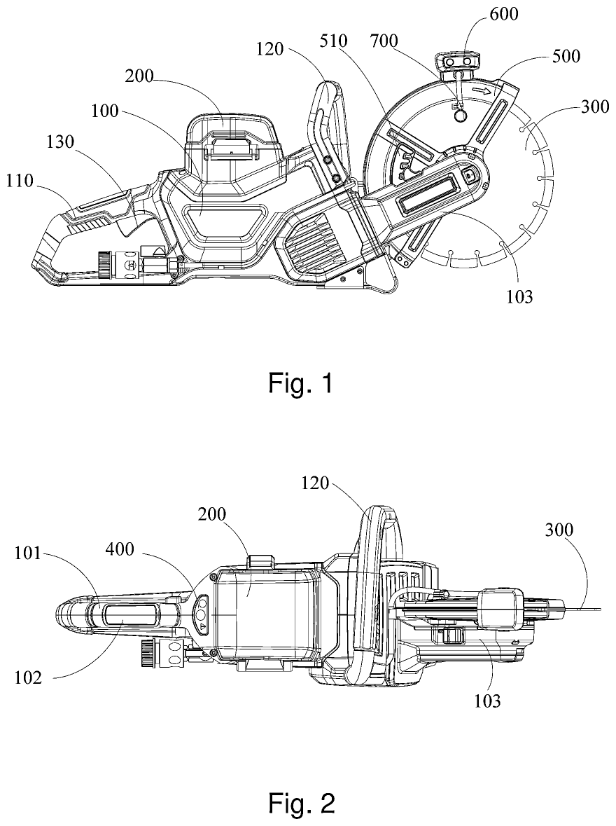

Please refer to FIG. 1 through FIG. 5. The disclosure provides a cutting saw. The cutting saw is centrally provided with a power supply switch 402, a lighting switch 401 and an alarm light 403 on a same operating panel 400. This arrangement enables relatively centralized a control of the cutting saw, and may improve a problem that settings of conventional cutting saw switches are relatively scattered, resulting in a poor user's experience and being inconvenient for operators to operate.

Please refer to FIG. 1 through FIG. 5. The cutting saw includes a housing 100, a cutting part 300, a driving part (not labeled), a power supplying part 200, a lighting part 600 and a control board 800. A structure of the housing 100 is not limited and may be in various forms. The cutting part 300 may be rotatably installed on the housing 100 or an output shaft of the driving part and rotate under a drive of the driving part. The power supplying part 200 supplies power to the driving part, the lighting part 600 and the control board 800. The lighting part 600 provides light for the cutting saw. The control board 800 is electrically connected with the power supplying part 200 to obtain power supply. The control board 800 is electrically connected with the driving part to control an action of the driving motor 900, at the same time collects relevant parameters of the driving motor 900, determines a fault type according to the relevant parameters, and issues a corresponding alarm signal according to the determined fault type. The control board 800 is electrically connected with the lighting part 600 to control an on-off of the lighting part 600. The operating panel 400 is installed on the housing 100, and the power supply switch 402, the lighting switch 401 and the alarm light 403 are arranged on the operating panel 400. The power supply switch 402 is electrically connected with the control board 800 and controls a switch of the power supplying part 200. The lighting switch 401 is electrically connected with the control board 800 and controls the on-off of the lighting part 600. The alarm light 403 is electrically connected with the control board 800 and receives the corresponding alarm signal issued by the control board 800 to send an alarm.

Please refer to FIG. 2. In an embodiment of the disclosure, the housing 100 includes a first housing 101, a second housing 102 and a transmission box 103. The first housing 101 and the second housing 102 are mutually clamped to form a housing cavity (not labeled) inside. A first end of the transmission box 103 is connected with the first housing 101 and the second housing 102, and a second end of the transmission box 103 is cantilevered. The cutting part 300 includes a saw blade piece, which is rotatably installed on the transmission box 103 or the output shaft of the driving part, and is fully or at least partially exposed outside the transmission box 103 to grind or cut a product to be processed. The saw blade piece may be any suitable saw blade piece currently available, such as a diamond saw blade piece, a resin saw blade piece, etc. The driving part provides power for the cutting part 300. The driving part may be fully or partially installed in the transmission box 103 and drive the saw blade piece to rotate. The driving part may be any conventional structure that can drive the saw blade piece to rotate. In this embodiment, the driving part includes a driving motor 900 and a transmission structure (not shown). The transmission structure is installed in the transmission box 103, and the output shaft of the transmission box 103 extends out of the transmission box 103. The saw blade piece rotates driven by the output shaft. The motor is installed in the housing cavity defined by the first housing 101 and the second housing 102, and an output shaft of the driving motor 900 is connected with an input shaft of the transmission structure.

Please refer to FIG. 2. In an embodiment of the disclosure, the power supplying part 200 includes a battery cavity arranged on the first housing 101 and the second housing 102 and a battery pack inserted in the battery cavity. The battery cavity is clamped between the first housing 101 and the second housing 102, and the battery cavity is connected with the first housing 101 and the second housing 102 through a buckle, and a plugging piece base (not shown) for electrically connecting the driving part and the battery pack is further arranged at a bottom of the battery cavity.

Please refer to FIG. 2. In order to prevent wear and tear and to protect the operating panel 400, in one embodiment of the disclosure, the operating panel 400 is recessed into a surface of the housing 100 by 0 mm to 2 mm. This distance setting may ensure that the operating panel 400 will not be accidentally touched or worn when the cutting saw is placed, and on the other hand, it will not increase an operation difficulty due to the operating panel 400 being arranged too deep. In order to facilitate a blind touch by the user, in one embodiment of the disclosure, surfaces of the power supply switch 402 and the lighting switch 401 protrude from a surface of the operating panel 400 and are lower than the housing 100 around the operating panel 400, and have a characteristic of elastic self-resetting. Protruding structures of the power supply switch 402 and the lighting switch 401 may be in a form of spherical, cylindrical or other buttons. In this embodiment, the power supply switch 402 and/or the lighting switch 401 are soft keys and are spherical protrusions.

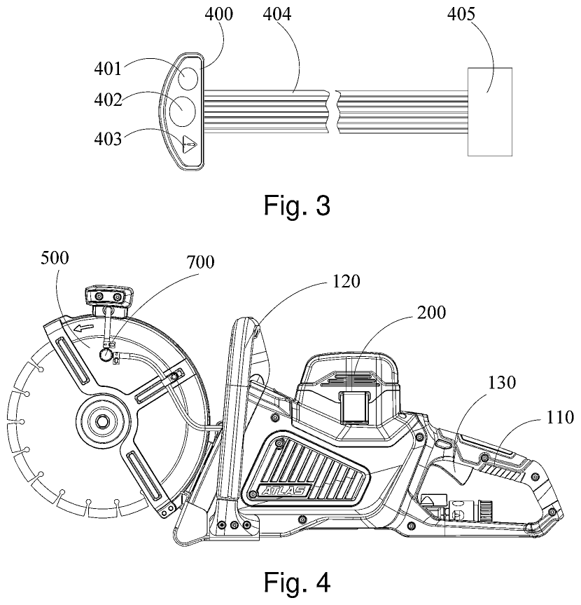

Please refer to FIG. 3. To facilitate subsequent electrical connection, in one embodiment of the disclosure, the operating panel 400 further includes a wiring part 404 and a plug-in connector 405. The wiring part 404 includes a belt body and a plurality of wires correspondingly arranged and integrated on the belt body. The plug-in connector 405 is arranged at one end of the belt body and is electrically connected with first ends of the plurality of wires, respectively. Second ends of the plurality of wires are electrically connected with the power supply switch 402, the lighting switch 401, and the alarm light 403, respectively. The power supplying part 200, the driving part, the lighting part 600, and the control board 800 are electrically connected with the plug-in connector 405 through other wires, respectively.

Please refer to FIG. 1 through FIG. 3. In an embodiment of the disclosure, the housing 100 further includes a first handle 110 arranged at an end of the battery cavity away from the cutting part 300 and a second handle 120 located at an end of the housing 100 toward the cutting part 300. The first handle 110 is formed by surroundings of the first housing 101 and the second housing 102. This arrangement, on one hand, enhances a stability of a connection between the first handle 110 and the housing 100, and on the other hand, it simplifies production operations and processes of the housing 100. Of course, in other embodiments of the disclosure, the first handle 110 may further be formed separately on the first housing 101 and/or the second housing 102, or the first handle 110 may further be arranged separately from the housing 100, and it is only necessary to ensure the stability of the connection between the first housing 110 and the housing 100. The second handle 120 is provided with a holding part arranged in an arch shape and a first fixing part and a second fixing part respectively located at two ends of the holding part. A first side of the second handle 120 is detachably installed on the first housing 101 through the first fixing part (not shown), and a second side of the second handle 120 is detachably installed on the second housing 102 through the second fixing part (not shown).

Please refer to FIG. 2 through FIG. 3. In an embodiment of the disclosure, the power supply switch 402 is centrally arranged on the operating panel 400 and close to a direction of fingers during a cutting operation (which means a side closer to the first handle), and the lighting switch 401 and the alarm light 403 are located on two sides of the power supply switch 402 and located on a side closer to the saw blade piece. In another embodiment, the lighting switch 401 and the alarm light 403 may also be located in front of the power supply switch 402. In order to facilitate a nighttime operation or to display activated state of each switch, in one embodiment of the disclosure, a light of the power supply switch (not shown) is arranged on the power supply switch 402 to reflect a state of the power supply switch 402. When the power supply switch 402 is in an activated mode, the light of the power supply switch is green, and when the power supply switch 402 is in an inactivated mode, the light of the power supply switch is turned off or displayed in other colors. The lighting switch 401 is provided with a lighting switch light (not shown) capable of reflecting a state of the lighting switch 401, when the lighting switch 401 is in the activated mode, the lighting switch light is white, and when the lighting switch 401 is in the inactivated mode, the lighting switch light is off. In an embodiment of the disclosure, a display color of the alarm light 403 is red. When a fault occurs during operation, a software setting of the control board 800 will control a flashing of the alarm light 403 according to an identification of the fault type. The alarm light 403 prompts different fault types through different flashing modes. The user may refer to an instruction manual according to a number of flashing warnings to find out fault problems corresponding to the different flashing numbers. In an embodiment of the disclosure, the cutting saw is further provided with a Bluetooth module. When a fault occurs during operation, the alarm light 403 flashes and sends the fault type and countermeasures to the user's mobile phone or computer, which enables it to be convenient for the user to troubleshoot the fault in time.

Please refer to FIG. 6. In an embodiment of the disclosure, when the power supply switch 402 is activated, a LED light of the power supply switch 402 lights up. If the control board 800 of the cutting saw does not receive any further control signal input within the first time threshold (for example 5 minutes), the light of the power supply switch starts to flash. If there is still no control signal input within the second time threshold (for example 10 seconds) after flashing, the power supply switch 402 enters an inactivated state.

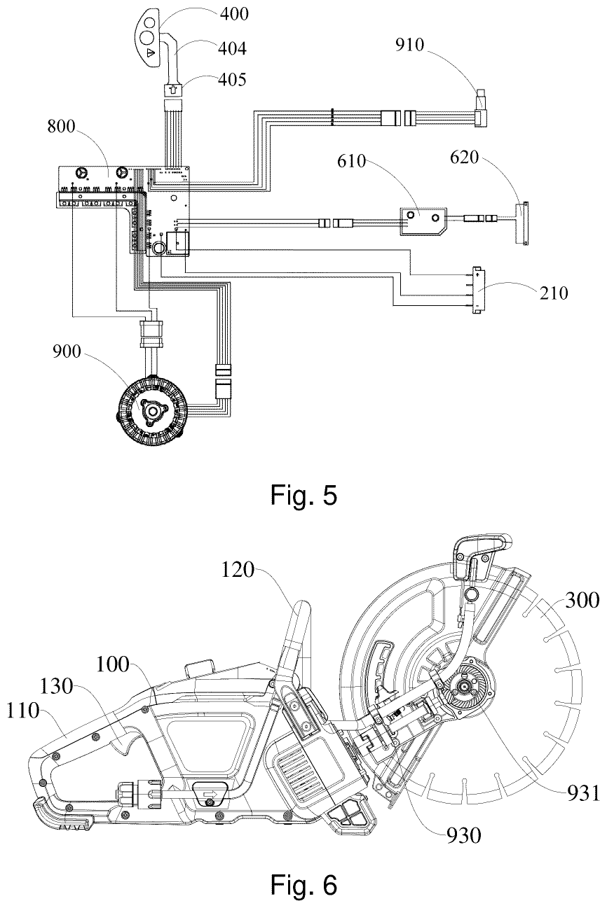

Please refer to FIG. 5. In an embodiment of the disclosure, the cutting saw further includes a speed regulation switch 910, and the speed regulation switch 910 is electrically connected with the control board 800 and controls a rotating speed of the motor in the driving part. The speed regulation switch 910 is arranged corresponding to the trigger 130, and the speed regulation switch 910 may be adjusted by pressing the trigger 130, thereby controlling the rotating speed of the motor in the driving part. In an embodiment of the disclosure, a charger plugging base 210 is further installed on the housing 100. The power supplying part 200 is electrically connected with the control board 800, and the control board 800 is electrically connected with the charger plugging base 210.

Please refer to FIG. 1, FIG. 2 and FIG. 4. In an embodiment of the disclosure, the cutting saw further includes a protective cover 500 and a spraying device 700. The protective cover 500 is arranged outside a part of the saw blade piece and is located on a side facing the user. The spraying device 700 is installed on the protective cover 500 and sprays coolant or lubricant onto a surface of the saw blade from two sides of the saw blade piece. An adjusting mechanism 510 is arranged on the protective cover 500. The protective cover 500 is rotatably installed outside the saw blade piece, and its position may be adjusted by the adjusting mechanism 510. The protective cover 500 is at least partially located above the saw blade and surrounds at least a part of the saw blade piece to prevent metal residues, concrete residues, etc. generated during a cutting process from splashing and injuring people.

Please refer to FIG. 1. In an embodiment of the disclosure, the lighting part 600 is used to illuminate an area to be cut and provide light for the cutting saw. The lighting part 600 includes a light and a light holder. The light is located above the saw blade piece, and two ends of the light extend to two sides of the saw blade piece, so that a lighting emitted by the light on both sides of the saw blade piece can fully illuminate a cutting line directly below the saw blade piece, thereby facilitating cutting by the user. The light includes an LED driving board 610 and an LED light board 620, the LED driving board 610 is electrically connected with the control board 800, and the LED light board 620 is electrically connected with the LED driving board 610. The LED light board 620 is fixedly installed on a side of the light holder facing the saw blade piece. The light holder is fixedly installed on a first protective wall and a second protective wall of the protective cover 500, so that the light holder has a sufficient installation space to allow the light to extend to both sides of a plane where the saw blade piece is located. Of course, the light holder in the disclosure may be further provided with a reflective bowl (not shown) and a dust-proof cover (not shown) that match the light. In this embodiment, the light is fixedly installed on the protective cover 500. However, in other embodiments, the light may further be fixedly installed on an auxiliary handle.

Please refer to FIG. 2. In an embodiment of the disclosure, the power supply switch 402 and the lighting switch 401 are arranged at positions that may be touched by fingers during the cutting operation, for example, they may be arranged at positions that may be touched by fingers holding the first handle 110 during the cutting operation, or they may be arranged at positions that may be touched by fingers holding the second handle 120 during the cutting operation. In an embodiment of the disclosure, considering that the trigger 130 of conventional cutting saws is mostly arranged on an inner side of the first handle 110, the operating panel 400 is arranged on a surface between the battery cavity and the first handle 110, and is located at a position that is convenient for the user to lower his head to check the operation. With this arrangement, the user may conveniently operate the power supply switch 402 without having to shift a sight further after installing the battery pack, and after the power supply switch 402 is activated, a reverse self-locking of the trigger 130 and the trigger 130 are pressed to start the machine. It may also press the lighting switch 401 to start the light as needed. This arrangement is more ergonomic.

Please refer to FIG. 6. In order to improve a problem that there are many saw blades with different diameters on a market, it is necessary to be provided with one or two or even multiple specifications of shaft sleeves, which enables that if the user change the saw blade in daily use, the user only need to change the shaft sleeve up and down to match the saw blade with a corresponding diameter and it is convenient, simple, and very user-friendly. In this embodiment, the cutting saw further includes a shaft sleeve 1100. The driving part is at least partially installed in the housing 10 and driving the cutting part 300 to rotate, and includes a driving motor 900 and a transmission mechanism 930. The driving motor 900 is installed in the housing 100, the transmission mechanism 930 is connected with the driving motor 900 and installed on an outer side of the housing 10, and the shaft sleeve 1100 is sleeved on an output shaft 931 of the transmission mechanism 930. The cutting part 300 with different through hole diameters may be matched and installed through the shaft sleeve 1100, and the cutting part 300 is driven to rotate through the driving motor 900 and the transmission mechanism 930.

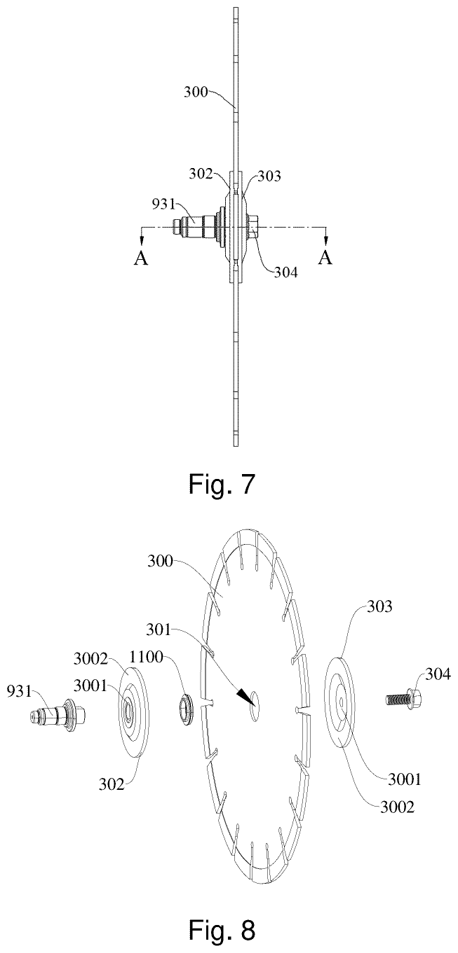

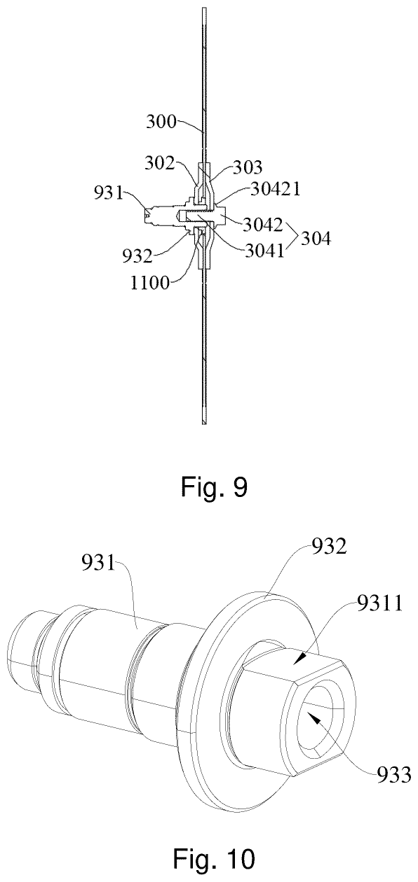

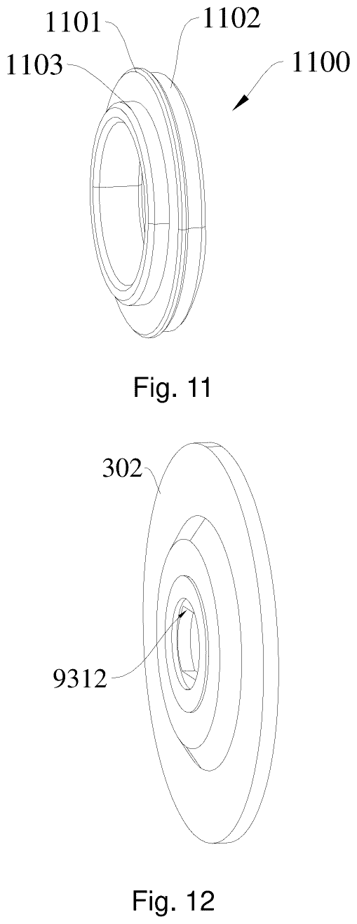

Please refer to FIG. 6 through FIG. 12. In this embodiment, the shaft sleeve 1100 is formed with a plurality of shaft surfaces with different diameters so that the shaft sleeve 1100 may be adapted to the cutting part 300 with different through hole diameters, and the shaft surfaces are located on two sides of a center plane of the shaft sleeve 1100. In an embodiment, the shaft sleeve 1100 is further formed with a first shaft shoulder 1101, and a circumferential surface of the first shaft shoulder 1101 is the center surface of the shaft sleeve. The shaft surface includes a first shaft surface 1102 and a second shaft surface 1103, and the first shaft surface 1102 and the second shaft surface 1103 are located on two sides of the first shaft shoulder 1101, which means on both sides of the center surface of the shaft sleeve 1100. The first shaft shoulder 1101 protrudes from the first shaft surface 1102 and the second shaft surface 1103, which means that an outer diameter of the first shaft shoulder 1101 is larger than diameters of the first shaft surface 1102 and the second shaft surface 1103, so as to facilitate a limiting of the cutting part 300 installed on the first shaft surface 1102 and the second shaft surface 1103. The diameter of the first shaft surface 1102 is larger than the diameter of the second shaft surface 1103.

Please refer to FIG. 6 through FIG. 12. In this embodiment, a through hole 301 is arranged at a center of the cutting part 300, and the through hole 301 is matched with the shaft surface to connect the through hole 301 with the shaft sleeve 1100, so that the cutting part 300 and the shaft sleeve 1100 may be matched and installed. The through hole 301 may be set to different diameters according to actual needs, and the diameters of the first shaft surface 1102 and the second shaft surface 1103 may also be set in coordination with the through hole 301 according to the actual needs. For example, when the diameter of the through hole 301 is set to 25.4 mm, the diameter of the first shaft surface 1102 may also be set to 25.4 mm. Therefore, the through hole 301 may be installed in coordination with the first shaft surface 1102. When the diameter of the through hole 301 is set to 20 mm, the diameter of the second shaft surface 1103 may also be set to 20 mm. Therefore, the through hole 301 may be installed in coordination with the second shaft surface 1103. The shaft sleeve 1100 is provided with the first shaft surface 1102 and the second shaft surface 1103 with different diameters, wherein, the diameters of the first shaft surface 1102 and the second shaft surface 1103 are installed in coordination with the through holes 301 of different cutting parts 300, so that the cutting part 300 on the cutting saw may be quickly replaced, which is convenient for the user to use. During use, the user may select the first shaft surface 1102 or the second shaft surface 1103 that matches the through hole 301 of the cutting part 300 for installation as needed. When a different cutting part 300 needs to be replaced, it is only necessary to change a direction of the shaft sleeve 1100, which is convenient and quick.

Please refer to FIG. 6 through FIG. 12. In this embodiment, a first pressing plate 302 and a second pressing plate 303 are installed on two sides of the cutting part 300, and the cutting part 300 is fixed on the output shaft 931 through the first pressing plate 302 and the second pressing plate 303. The shaft sleeve 1100 is located between the first pressing plate 302 and the second pressing plate 303. In an embodiment, the cutting part 300 is matched and installed on the shaft sleeve 1100, then the first pressing plate 302 and the second pressing plate 303 are used to limit the cutting part 300 on the output shaft 931, and the shaft sleeve 1100 is located between the first pressing plate 302 and the second pressing plate 303. It should be noted that, a second shaft shoulder 932 is coaxially arranged on the output shaft 931, and an outer diameter of the second shaft shoulder 932 is larger than a diameter of the output shaft 931. A threaded hole 933 is arranged on an end of the output shaft 931 close to the installed cutting part 300. The threaded hole 933 is opened along an axial direction of the output shaft 931 and a locking bolt 304 may be connected in the threaded hole. The locking bolt 304 includes a screw rod 3041 and a nut 3042. The screw rod 3041 is connected with the threaded hole 933 by threads, and a gasket is arranged on the screw rod 3041. A diameter of the gasket is larger than a diameter of the through hole in a center of the second pressing plate 303, and the gasket is located between the nut 3042 and the second pressing plate 303, or the nut 3042 protrudes outward along a circumference on a contacting surface with the second pressing plate 303 to form a protruding part 30421, and a diameter of the protruding part 30421 is larger than the diameter of the through hole in the center of the second pressing plate 303, so that when the locking bolt 304 is tightened, the gasket is pressed on the second pressing plate 303, thereby fixing the cutting part 300. When mounting, the first pressing plate 302 and the cutting part 300 are concentrically sleeved on the output shaft 931, a first side of the first pressing plate 302 is in a close contact with a side surface of the second shaft shoulder 932, and a second side of the first pressing plate 302 is in a close contact with the side surface of the cutting part 300. The second pressing plate 303 is sleeved on the locking bolt 304, a first side of the second pressing plate 303 is in a close contact with the other side surface of the cutting part 300, and a second side of the second pressing plate 303 is in a close contact with the locking bolt 304. The locking bolt 304 presses a side surface of the second pressing plate 303 to lock and fix it. The first pressing plate 302, the cutting part 300 and the second pressing plate 303 are fixedly arranged between the second shaft shoulder 932 and the locking bolt 304 in sequence, and the second shaft shoulder 932 and the locking bolt 304 form an axial limitation for the first pressing plate 302, the cutting part 300 and the second pressing plate 303 in sequence. The cutting part 300 may be fixedly connected to the output shaft 931 through an arrangement of the second shaft shoulder 932, the first pressing plate 302, the second pressing plate 303 and the locking bolt 304, and may be rotated to perform a cutting under a driving of the output shaft 931. In this embodiment, the first pressing plate 302 and the second pressing plate 303 both include a middle part 3001 and an edge part 3002, and the middle part 3001 protrudes from the edge part 3002, which means that the middle parts 3001 of the first pressing plate 302 and the second pressing plate 303 are concave to one side so that the middle part 3001 protrudes from the edge part 3002. And the first pressing plate 302 and the second pressing plate 303 are concave in opposite directions. When mounting, the edge parts 3002 are tightly attached to the cutting part 300, and there is a gap between the middle parts 3001 and the cutting part 300, so that when the first pressing plate 302 and the second pressing plate 303 are fixed by the locking bolt 304, the locking bolt 304 is located on a through hole in a center of the middle part 3001. The locking bolt 304 is tightened to squeeze the middle parts 3001, so that the edge parts 3002 are tightly pressed against a surface of the cutting part 300, which may better press and fix the cutting part 300.

Please refer to FIG. 6 through FIG. 12. In this embodiment, when mounting the cutting part 300, the first pressing plate 302 is first sleeved on the output shaft 931, so that one side of the first pressing plate 302 is in close contact to the second shaft shoulder 932, then the shaft sleeve 1100 is sleeved and mounted on the output shaft 931, and a shaft surface of the shaft sleeve 1100 that matches the through hole 301 is located on a side away from the first pressing plate 302. The first shaft surface 1102 or the second shaft surface 1103 may be located on one side away from the first pressing plate 302, and then the through hole 301 of the cutting part 300 is matched and mounted with the first shaft surface 1102 or the second shaft surface 1103. Then the locking bolt 304 passes through the through hole of a center of the second pressing plate 303, and the locking bolt 304 is tightened with the threaded hole 933 to enable the second pressing plate 303 to be pressed on the cutting part 300 tightly, so that the cutting part 300 is fixed on the output shaft 931 under an action of the first pressing plate 302 and the second pressing plate 303. When the cutting part 300 with different sizes needs to be replaced, it is only necessary to change a sleeving direction of the shaft sleeve 1100, select a shaft surface matching a diameter of the through hole 301, and then mount the cutting part 300, the second pressing plate 303 and the locking bolt 304 according to the above method. It should be noted that, in this embodiment, the output shaft 931 is symmetrically provided with a first plane structure 9311 on the shaft surface where the cutting part 300 is mounted. Similarly, the first pressing plate 302 matching the output shaft 931 is provided with a second plane structure 9312 matched with the first plane structure 9311. Specifically, the second plane structure 9312 is arranged on a side wall of the through hole in a center of the first pressing plate 302 so as to be matched with the first plane structure 9311 on the output shaft 931 to prevent a relative rotation between the first pressing plate 302 and the output shaft 931, thereby improving rotation efficiency of the cutting part 300. In this embodiment, the first plane structure 9311 is matched with the second plane structure 9312 so that the first pressing plate 302 may rotate along with the output shaft 931, thereby driving the cutting part 300 to rotate and work.

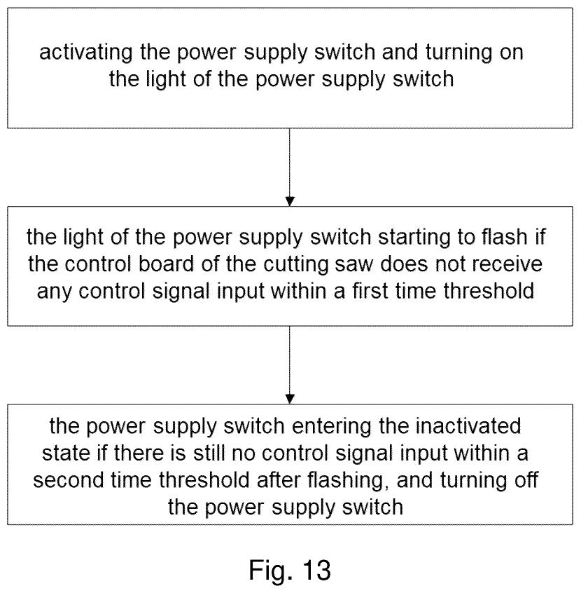

Please refer to FIG. 13. The disclosure further provides a control method of the cutting saw, which includes:
activating the power supply switch and turning on the light of the power supply switch;
the light of the power supply switch starting to flash if the control board of the cutting saw does not receive any control signal input within a first time threshold; and
the power supply switch entering the inactivated state if there is still no control signal input within a second time threshold after flashing, and turning off the power supply switch.

In an embodiment of the disclosure, when the power supply switch is in an activated mode, the light of the power supply switch is green, and when the power supply switch is in an inactivated mode, the light of the power supply switch is turned off or displayed in other colors, for example white, blue and so on.

In an embodiment of a control method of the disclosure, when a fault occurs during operation of the cutting saw, flashing times and/or colors of an alarm light are controlled to indicate a type of the corresponding fault. In an embodiment of the disclosure, a display color of the alarm light 403 is red. When a fault occurs during operation, a software setting of the control board 800 will control a flashing pattern of the alarm light 403 according to an identification of the fault type. The alarm light 403 prompts different fault types through different flashing modes. The operator may know the corresponding fault type according to the flashing pattern of the alarm light 403 (such as the times of flashes and/or the color).

For example, in an embodiment of the disclosure, the corresponding fault type is indicated by the times of flashes of the alarm light 403. When an actual speed of the motor is less than a set minimum rotating speed, the motor stops working and reports an error, and the motor enters a low-speed protection mode. The alarm light 403 flashes once, and at this time the operator may release the trigger and restart the machine. When the controller self-test fails, the alarm light 403 flashes twice. The operator may unplug the battery pack and restart the machine. If a problem persists, the controller is replaced. When battery pack communication abnormalities such as that the battery pack fails to connect to the control board or a connection is suddenly interrupted during normal communication occurs, the alarm light 403 flashes 3 times. At this time the battery pack is unplugged and the machine is restarted. If the problem persists, the controller is replaced. When a phase current exceeds a set protection value or a bus current exceeds the set protection value while the motor is running, and an overcurrent protection occurs, the alarm light 403 flashes 4 times. At this time, the operator may release the trigger and restart the machine. When an input voltage is lower, such as a battery pack voltage is lower than a motor starting voltage, or when the motor is running and a battery voltage is lower than a minimum working voltage, the alarm light 403 flashes 5 times, and the operator may replace the battery pack with a full charged one. When a temperature of the controller exceeds the set protection value during working and the controller is in high temperature protection mode, the alarm light 403 flashes 6 times. It is necessary to wait for the controller to cool down before using the machine. When the motor encounters resistance when starting or running and the motor cannot continue to run, or when the motor starts or runs with a phase change error and the motor cannot continue to run, or when there are problems such as Hall signal abnormalities on a Hall sensor motor, the alarm light 403 flashes 7 times, the operator may release the trigger and restart the machine. If the problem persists, the controller is replaced. If a sequence of buttons is incorrect or some buttons fail when starting the machine, the alarm light 403 flashes 8 times. The trigger is released and the motor is restarted in a correct sequence. If the problem persists, the controller is replaced. When a software authentication code is running, a CU exception is detected, the alarm light 403 flashes 9 times. The battery pack is unplugged and the machine is restarted. If the problem persists, the controller is replaced. When a temperature of the motor exceeds the set protection value during working or starting, the alarm light 403 flashes 10 times. The operator may select to wait for the controller to cool down before using the machine. When a temperature of the battery pack exceeds the set protection value during working of the control board, the alarm light 403 flashes 11 times. The operator may select to wait for the controller to cool down before using the machine.

The disclosure provides the cutting saw, which ensures a use of two kinds of saw blades through arranging the shaft sleeve with shaft surface of different diameters, and does not need to design the shaft sleeves of the two kinds of the saw blade at the same time, which saves costs and is convenient for daily use, saving time and effort. In addition, the shaft sleeve can match the two kinds of the saw blades of the cutting saw, so that in daily work, a user no longer needs to worry about incorrect diameters when replacing the saw blade. The two diameters of the shaft sleeves may match most saw blades on the market, which is convenient for users to use.

The disclosure provides the cutting saw, which only uses a dual-purpose shaft sleeve. The shaft sleeve is assembled on the cutting saw. If the saw blade is replaced in daily use, it is only necessary to replace the shaft sleeve in up and down directions to match the saw blade with the corresponding diameters, which is convenient and simple, and very user-friendly. The saw blade may be replaced very simply and will not be lost in daily use.

The cutting saw and the control method of the disclosure have advantages of good control experience, high intelligence, and easy detection of fault alarms. Therefore, the disclosure effectively overcomes some practical problems in the prior art, thereby having high utilization value and use significance.

The above embodiments only illustrate principles and effects of the disclosure, but are not intended to limit the disclosure. Anyone familiar with this technology may modify or change the above embodiments without departing from a scope of the disclosure. Therefore, all equivalent modifications or changes made by those with ordinary knowledge in the technical field without departing from the technical ideas disclosed in the disclosure shall still be covered by the claims of the disclosure.

What is claimed is:

1. A cutting saw, comprising:
a cutting part;
a driving part, the driving part supplying power to the cutting part;
a power supplying part, the power supplying part supplying power to the cutting saw;
a lighting part, the lighting part providing light for the cutting saw;
a control board, the control board electrically connected with the power supplying part, the driving part and the lighting part respectively; and
a housing, the housing provided with an operating panel, the operating panel provided with:
a power supply switch, the power supply switch electrically connected with the control board and controlling a switch of the power supplying part,
a lighting switch, the lighting switch electrically connected with the control board and controlling an on-off of the lighting part, and
an alarm light, the alarm light electrically connected with the control board and receiving a corresponding alarm signal from the control board to give an alarm;
wherein, when the power supply switch is activated, a light of the power supply switch lights up, if the control board of the cutting saw does not receive a control signal input within a first time threshold, the light of the power supply switch starts to flash, and if there is still no control signal input within a second time threshold after flashing, the power supply switch enters an inactivated state and the light of the power supply switch is turned off.

2. The cutting saw according to claim 1, wherein, the power supply switch and the lighting switch are arranged at touchable positions of fingers during a cutting operation.

3. The cutting saw according to claim 1, wherein, the housing is provided with a battery cavity to install the power supplying part, a first handle is arranged on a side of the battery cavity away from the cutting part, the operating panel is arranged on an outer surface of the housing between the first handle and the battery cavity, and the operating panel is recessed into the outer surface of the housing by 0 mm to 2 mm.

4. The cutting saw according to claim 1, wherein, surfaces of the power supply switch and the lighting switch protrude from a surface of the operating panel, and the surfaces of the power supply switch and the lighting switch are lower than the housing surrounding the operating panel.

5. The cutting saw according to claim 1, wherein, the operating panel further comprises a wiring part and a plug-in connector, the plug-in connector is electrically connected to the power supply switch, the lighting switch, and the alarm light through the wiring part, and the power supplying part, the driving part, the lighting part, and the control board are electrically connected with the plug-in connector through other wires.

6. The cutting saw according to claim 1, wherein, the power supply switch is centrally arranged on the operating panel and close to a direction of fingers during a cutting operation, and the lighting switch and the alarm light are located on two sides of the power supply switch.

7. The cutting saw according to claim 1, wherein, the lighting switch is provided with a lighting switch light capable of reflecting a state of the lighting switch, when the lighting switch is in an activated mode, the lighting switch light is white, and when the power supply switch is in an inactivated mode, the lighting switch light is off.

8. The cutting saw according to claim 1, further comprising a speed regulation switch, the speed regulation switch electrically connected with the control board and configured to control a rotating speed of a motor in the driving part.

9. The cutting saw according to claim 1, wherein, the lighting part comprises an LED driving board and an LED light board, the LED driving board is electrically connected with the control board, and the LED light board is electrically connected with the LED driving board.

10. The cutting saw according to claim 1, further comprising a charger plugging base, wherein, the power supplying part is electrically connected with the control board, and the control board is electrically connected with the charger plugging base.

11. The cutting saw according to claim 1, further comprising a shaft sleeve, sleeved on an output shaft of the driving part, wherein the shaft sleeve is provided with shaft surfaces of different diameters, and the shaft surfaces are arranged on two sides of a center plane of the shaft sleeve and are installed in cooperation with the cutting part.

12. The cutting saw according to claim 1, wherein, a first shaft shoulder is further arranged on the shaft sleeve, the shaft surface comprises a first shaft surface and a second shaft surface, the first shaft surface and the second shaft surface are arranged on two sides of the first shaft shoulder, an outer diameter of the first shaft shoulder is larger than diameters of the first shaft surface and the second shaft surface, and the diameter of the first shaft surface is larger than the diameter of the second shaft surface.

13. A control method of a cutting saw, comprising:
activating a power supply switch and turning on a light of the power supply switch;
the light of the power supply switch starting to flash if a control board of the cutting saw does not receive any control signal input within a first time threshold;
the power supply switch entering an inactivated state if there is still no control signal input within a second time threshold after flashing, and turning off the power supply switch.

14. The control method according to claim 13, wherein, when the power supply switch is in an activated mode, the light of the power supply switch is green, and when the power supply switch is in an inactivated mode, the light of the power supply switch is turned off or displayed in other colors.

15. The control method according to claim 13, wherein, when a fault occurs during operation of the cutting saw, flashing times and/or colors of an alarm light are controlled to indicate a type of the corresponding fault.
